(19) United States
(12) Patent Application Publication
(10) Pub. No.: US 2025/0027385 A1
(43) Pub. Date: Jan. 23, 2025

(54) AUTOMATED TOOLS RECOMMENDER SYSTEM FOR WELL COMPLETION

(71) Applicant: Schlumberger Technology Corporation, Sugar Land, TX (US)

(72) Inventors: Siraput Jongaramrungruang, Houston, TX (US); John Pang, Cupertino, CA (US); Andrey Sergeevich Konchenko, Houston, TX (US); Jose R. Celaya Galvan, Menlo Park, CA (US)

(21) Appl. No.: 18/714,930

(22) PCT Filed: Nov. 29, 2022
(86) PCT No.: PCT/US2022/051147

§ 371 Date: May 30, 2024

Related U.S. Application Data
(60) Provisional application No. 63/284,601, filed on Nov. 30, 2021.

(51) Int. Cl. E21B 41/00; G06N 3/09; G06N 20/00

(52) U.S. Cl. CPC E21B 41/00; G06N 3/09; G06N 20/00; E21B 2200/20; E21B 2200/22

(57) ABSTRACT

The present disclosure relates to the application of machine learning algorithms to recommend one or more tools for completion of a well, based on the features of the well. Predictive models may be built with the functionality of recommending one or more tools for a particular well completion. When the predictive models recommend the use of a tool, secondary predictive models may further recommend a particular tool selected from a group of tools. The predictions may achieve a high level of accuracy, and as such, may be used to recommend tools for well completion.

### CROSS-REFERENCE TO RELATED APPLICATIONS

This application claims the benefit of U.S. Provisional Application No. 63/284,601 entitled “Automated Tools Recommender System for Well Completion,” filed Nov. 30, 2021, the disclosure of which is incorporated herein by reference in its entirety.

### BACKGROUND

Well completion is the process of making a well ready for production after drilling operations. Planning for well completion may involve the selection and recommendation of various pieces of tools/components for different time periods. Well completion may apply to both land and off-shore drilling operations. Planning for well completion may involve a number of field experts studying the properties of the well to make recommendations based on the prior experiences of the field experts, and based on information on similar wells, that may be collated over time. This process of well completion may be time-consuming and erroneous due to a variety of reasons, such as human bias.

Well completion is an important value-adding process in oil and gas fields. The tools used for completion may be specific to a well and/or may be correlated to wells that are similar in terms of the geological features present in their respective locations. The problem of recommending a set of tools in well completion differs from other well-known recommendation systems such as movie recommendation on Netflix, or advertisements on social media. For example, when recommending a proportion of movies for a user on Netflix, additional information may be obtained for use in future recommendations. While technology such as collaborative filtering has proved to be very useful in such recommendation systems, it may be difficult to replicate success in a well completion setting. For example, failure to include an important and critical tool during well completion may result in a large amount of downtime for the well.

### BRIEF DESCRIPTION OF DRAWINGS

FIG. 1 shows a diagram of a field in accordance with one or more embodiments.

FIG. 2.1 and FIG. 2.2 show diagrams of systems in accordance with one or more embodiments.

FIG. 3.1 and FIG. 3.2 show flowcharts in accordance with one or more embodiments.

FIG. 4.1, FIG. 4.2, and FIG. 4.3 show examples in accordance with one or more embodiments.

FIGS. 5.1 and 5.2 show diagrams of computing systems in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The present disclosure relates to the application of machine learning algorithms to recommend one or more tools for completion of a well, based on the features of the well. The features may be categorical and/or numerical. Data from well completion records may be extracted and passed through a pipeline to clean and prepare the data for conversion to a machine learning friendly format. Predictive models may be built with the functionality of recommending one or more tools for a particular well completion. When the predictive models recommend the use of a tool, secondary predictive models may further recommend a particular tool selected from a group of tools. The predictions may achieve a high level of accuracy, and as such, may be used to recommend tools for well completion.

The present disclosure describes two different machine learning models for well completion: (i) an unsupervised clustering model to group similar wells, and (ii) a trained multi-task classification model to determine if a well has a requirement for one or more particular tool types based on known conditions and features of the well. Using unsupervised learning permits the construction of high-level (e.g., aggregated) features and hierarchical representations from historical data.

The trained multi-task classification model may use an oversampling algorithm that generates a training dataset that is balanced for one or more tasks. The multi-task classification model predicts a requirement for a particular tool (e.g., a particular technology) and/or the type of tool. Thus, a single machine learning model may simultaneously predict a requirement and a type of tool to fulfill the requirement. The classification model may predict multiple requirements and multiple types of tools to fulfill the multiple requirements. A pre-processing step including data cleaning, feature engineering, and/or oversampling may be performed before training the classification model.

Automated recommendations for well completion (e.g., a sand control or the type of flow control valve) may be generated using the aforementioned machine learning models. The present disclosure provides evidence that tool recommendation is possible using trained and/or unsupervised machine learning models, and may be used to augment human understanding and expertise.

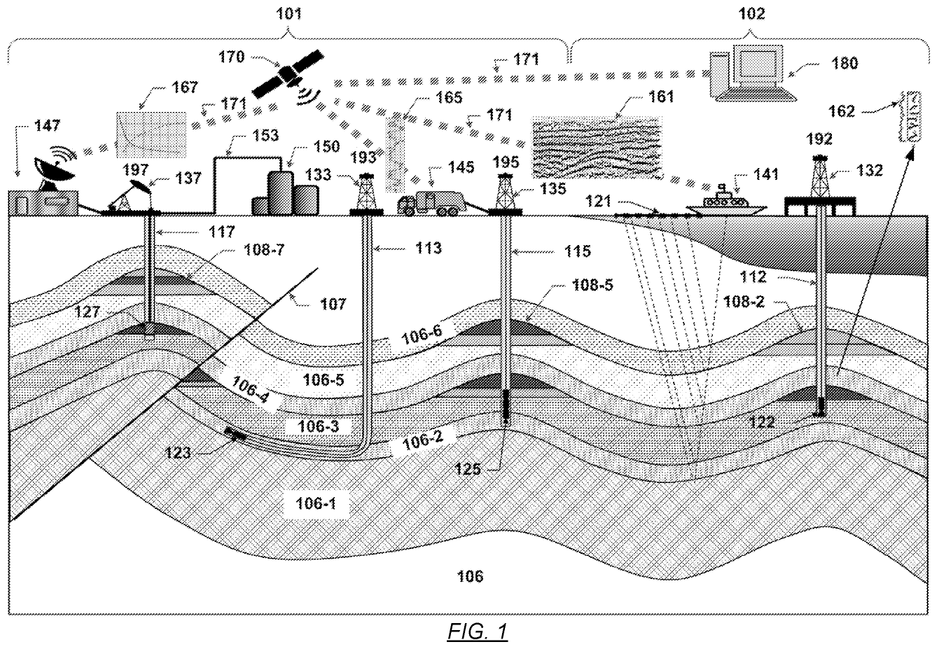

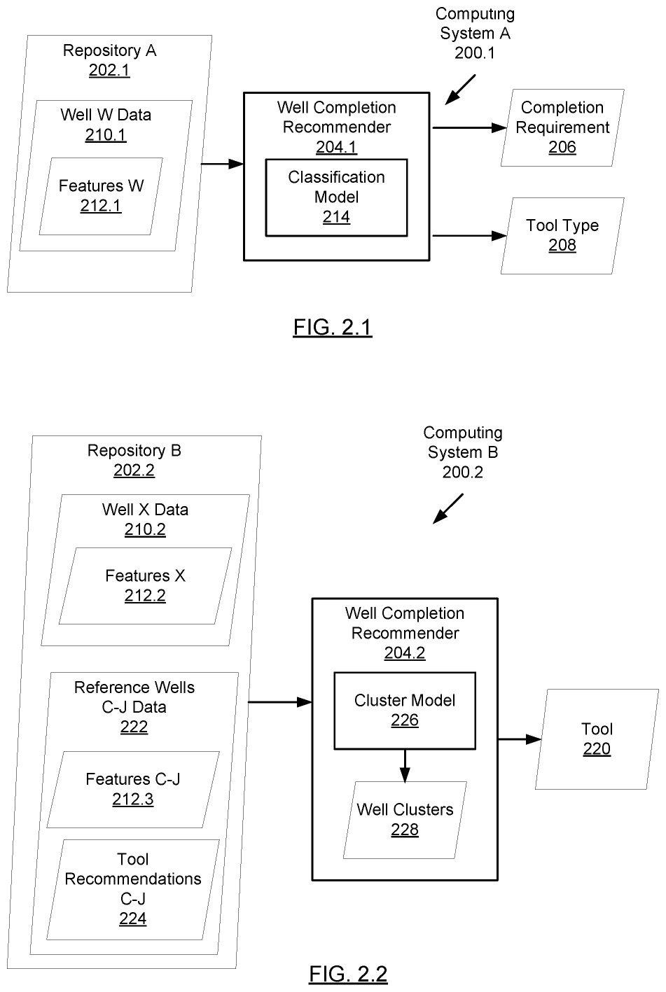

FIG. 1 depicts a schematic view, partially in cross section, of an onshore field (101) and an offshore field (102) in which one or more embodiments may be implemented. In one or more embodiments, one or more of the modules and elements shown in FIG. 1 may be omitted, repeated, and/or substituted. Accordingly, embodiments should not be considered limited to the specific arrangement of modules shown in FIG. 1.

As shown in FIG. 1, the fields (101), (102) include a geologic sedimentary basin (106), wellsite systems (192), (193), (195), (197), wellbores (112), (113), (115), (117), data acquisition tools (121), (123), (125), (127), surface units (141), (145), (147), well rigs (132), (133), (135), production equipment (137), surface storage tanks (150), production pipelines (153), and an E&P computer system (180) connected to the data acquisition tools (121), (123), (125), (127), through communication links (171) managed by a communication relay (170).

The geologic sedimentary basin (106) contains subterranean formations. As shown in FIG. 1, the subterranean formations may include several geological layers (106-1 through 106-6). As shown, the formation may include a basement layer (106-1), one or more shale layers (106-2, 106-4, 106-6), a limestone layer (106-3), a sandstone layer (106-5), and any other geological layer. A fault plane (107) may extend through the formations. In particular, the geologic sedimentary basin includes rock formations and may include at least one reservoir including fluids, for example the sandstone layer (106-5). In one or more embodiments, the rock formations include at least one seal rock, for example, the shale layer (106-6), which may act as a top seal. In one or more embodiments, the rock formations may include at least one source rock, for example the shale layer (106-4), which may act as a hydrocarbon generation source. The geologic sedimentary basin (106) may further contain hydrocarbon or other fluids accumulations associated with certain features of the subsurface formations. For example, accumulations (108-2), (108-5), and (108-7) associated with structural high areas of the reservoir layer (106-5) and containing gas, oil, water or any combination of these fluids.

In one or more embodiments, data acquisition tools (121), (123), (125), and (127), are positioned at various locations along the field (101) or field (102) for collecting data from the subterranean formations of the geologic sedimentary basin (106), referred to as survey or logging operations. In particular, various data acquisition tools are adapted to measure the formation and detect the physical properties of the rocks, subsurface formations, fluids contained within the rock matrix and the geological structures of the formation. For example, data plots (161), (162), (165), and (167) are depicted along the fields (101) and (102) to demonstrate the data generated by the data acquisition tools. Specifically, the static data plot (161) is a seismic two-way response time. Static data plot (162) is core sample data measured from a core sample of any of subterranean formations (106-1 to 106-6). Static data plot (165) is a logging trace, referred to as a well log. Production decline curve or graph (167) is a dynamic data plot of the fluid flow rate over time. Other data may also be collected, such as historical data, analyst user inputs, economic information, and/or other measurement data and other parameters of interest.

The acquisition of data shown in FIG. 1 may be performed at various stages of planning a well. For example, during early exploration stages, seismic data (161) may be gathered from the surface to identify possible locations of hydrocarbons. The seismic data may be gathered using a seismic source that generates a controlled amount of seismic energy. In other words, the seismic source and corresponding sensors (121) are an example of a data acquisition tool. An example of seismic data acquisition tool is a seismic acquisition vessel (141) that generates and sends seismic waves below the surface of the earth. Sensors (121) and other equipment located at the field may include functionality to detect the resulting raw seismic signal and transmit raw seismic data to a surface unit (141). The resulting raw seismic data may include effects of seismic wave reflecting from the subterranean formations (106-1 to 106-6).

After gathering the seismic data and analyzing the seismic data, additional data acquisition tools may be employed to gather additional data. Data acquisition may be performed at various stages in the process. The data acquisition and corresponding analysis may be used to determine where and how to perform drilling, production, and completion operations to gather downhole hydrocarbons from the field. Generally, survey operations, wellbore operations and production operations are referred to as field operations of the field (101) or (102). These field operations may be performed as directed by the surface units (141), (145), (147). For example, the field operation equipment may be controlled by a field operation control signal that is sent from the surface unit.

Further as shown in FIG. 1, the fields (101) and (102) include one or more wellsite systems (192), (193), (195), and (197). A wellsite system is associated with a rig or a production equipment, a wellbore, and other wellsite equipment configured to perform wellbore operations, such as logging, drilling, fracturing, production, or other applicable operations. For example, the wellsite system (192) is associated with a rig (132), a wellbore (112), and drilling equipment to perform drilling operation (122). In one or more embodiments, a wellsite system may be connected to a production equipment. For example, the well system (197) is connected to the surface storage tank (150) through the fluids transport pipeline (153).

In one or more embodiments, the surface units (141), (145), and (147), are operatively coupled to the data acquisition tools (121), (123), (125), (127), and/or the wellsite systems (192), (193), (195), and (197). In particular, the surface unit is configured to send commands to the data acquisition tools and/or the wellsite systems and to receive data therefrom. In one or more embodiments, the surface units may be located at the wellsite system and/or remote locations. The surface units may be provided with computer facilities (e.g., an E&P computer system) for receiving, storing, processing, and/or analyzing data from the data acquisition tools, the wellsite systems, and/or other parts of the field (101) or (102). The surface unit may also be provided with, or have functionality for actuating, mechanisms of the wellsite system components. The surface unit may then send command signals to the wellsite system components in response to data received, stored, processed, and/or analyzed, for example, to control and/or optimize various field operations described above.

In one or more embodiments, the surface units (141), (145), and (147) are communicatively coupled to the E&P computer system (180) via the communication links (171). In one or more embodiments, the communication between the surface units and the E&P computer system may be managed through a communication relay (170). For example, a satellite, tower antenna or any other type of communication relay may be used to gather data from multiple surface units and transfer the data to a remote E&P computer system for further analysis. Generally, the E&P computer system is configured to analyze, model, control, optimize, or perform management tasks of the aforementioned field operations based on the data provided from the surface unit. In one or more embodiments, the E&P computer system (180) is provided with functionality for manipulating and analyzing the data, such as analyzing seismic data to determine locations of hydrocarbons in the geologic sedimentary basin (106) or performing simulation, planning, and optimization of E&P operations of the wellsite system. In one or more embodiments, the results generated by the E&P computer system may be displayed for user to view the results in a two-dimensional (2D) display, three-dimensional (3D) display, or other suitable displays. Although the surface units are shown as separate from the E&P computer system in FIG. 1, in other examples, the surface unit and the E&P computer system may also be combined.

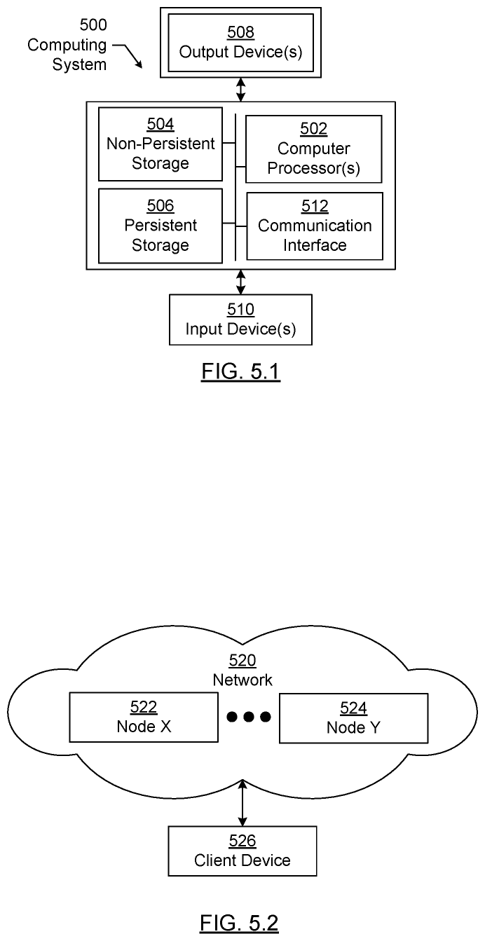

In one or more embodiments, the E&P computer system (180) is implemented by an E&P services provider by deploying applications with a cloud based infrastructure. As an example, the applications may include a web application that is implemented and deployed on the cloud and is accessible from a browser. Users (e.g., external clients of third parties and internal clients of the E&P services provider) may log into the applications and execute the functionality provided by the applications to analyze and interpret data, including the data from the surface units (141), (145), and (147). The E&P computer system and/or surface unit may correspond to a computing system, such as the computing system shown in FIGS. 5.1 and 5.2 and described below.

FIG. 2.1 is a diagram of a computing system (200.1) in accordance with one or more embodiments of the disclosure. The computing system (200.1) may be a computing system such as described below with reference to FIGS. 5.1 and 5.2. For example, the computing system (200.1) may be the E&P computing system described in reference to FIG. 1. In one or more embodiments, the computing system (200.1) includes a repository (202.1) and a well completion recommender (204.1). The repository (202.1) may be any type of storage unit and/or device (e.g., a file system, database, collection of tables, or any other storage mechanism) for storing data. Further, the repository (202.1) may include multiple different storage units and/or devices. The multiple different storage units and/or devices may or may not be of the same type or located at the same physical site.

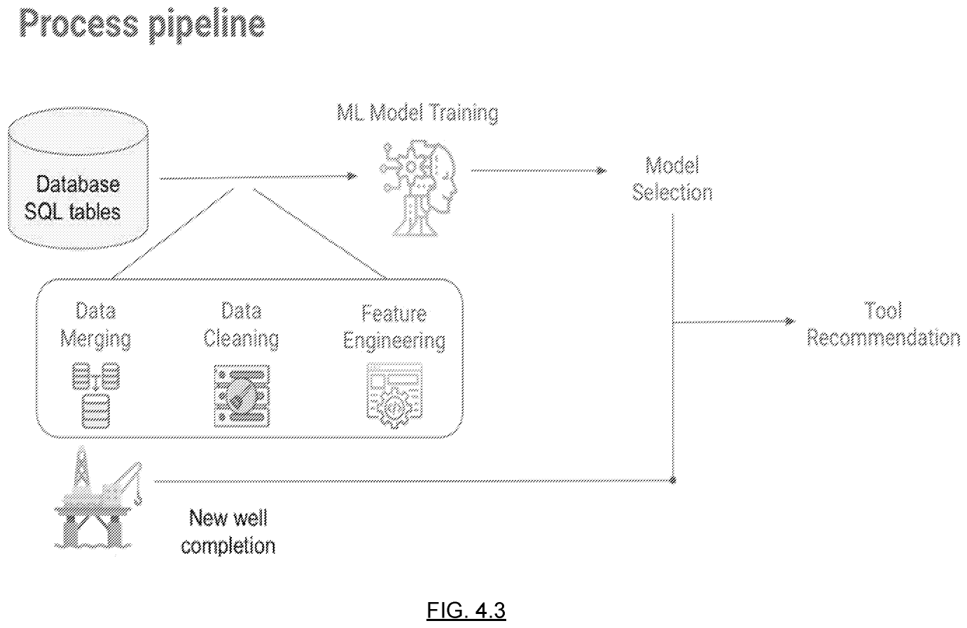

The repository (202.1) includes well data (210.1) for a well. The well may be an element included in FIG. 1. The well data (210.1) includes features (212.1) of the well. The features (212.1) may be geological features of subsurface formations. The features (212.1) may include categorical and/or numerical features. An example of a categorical feature is “rock type.” A numerical range may be associated with a numerical feature. In a Well Tracker database of approximately 20,000 wells and more than 200 features, some well data was omitted because tools corresponding to a feature in the well data were not utilized. A subset of 47 common features may be retained, representing at least 10% of the wells. Next, cleaning procedures may be applied to select features best suited for clustering and/or classification tasks. For example, categorical features such as ‘Country_ID’, ‘Completion #’, ‘Type_ID’, ‘StringType_ID’, ‘Material_ID’, ‘Reason ID’, ‘WellType_ID’, ‘UpperCompletion_ID’, MultiLateral_ID', ‘Completion_Type’, ‘ArtificialLift_Type’, together with numerical features such as ‘Geometry_WellGeometry’, ‘Geometry_VertOrder’, ‘Pressure’, ‘Temperature’, ‘MDTop’, ‘MDBottom’, ‘TubularSize_OD_decimal_mm’, and ‘TubularSize_Weight_kg_per_m’ were among the most important features. FIG. 4.1 shows an example of features ranked by importance for different tool types.

The well completion recommender (204.1) includes functionality to recommend, using the features (212.1) of the well, a completion requirement (206) and/or a tool type (208). The well completion recommender (204.1) includes a classification model (214). The classification model (214) may be a multi-task classifier that determines a completion requirement (206) for the well. The completion requirement (206) may be any requirement which when fulfilled, contributes toward the completion of the well. An example of a completion requirement is “flow control needed.” The classification model (214) may further determine a tool type (208) to fulfill the completion requirement (206). For example, FIG. 4.2 shows that the completion requirement “flow control” may be fulfilled by the tool types “gas lift control,” “comingled & interventionless control,” and “injection control.” A tool type (208) may correspond to one or more tools.

The classification model (214) may be trained using training data that includes features of wells labeled with a completion requirement and/or a tool type. That is, the classification model (214) may learn the relationship between features of wells and completion requirements and/or tool types.

The classification model (214) may be implemented as various types of deep learning classifiers and/or regressors based on neural networks (e.g., based on convolutional neural networks (CNNs)), random forests, stochastic gradient descent (SGD), a lasso classifier, gradient boosting (e.g., XGBoost), bagging, adaptive boosting (AdaBoost), ridges, elastic nets, or Nu Support Vector Regression (NuSVR). Deep learning, also known as deep structured learning or hierarchical learning, is part of a broader family of machine learning methods based on learning data representations, as opposed to task-specific algorithms.

FIG. 2.2 is a diagram of a computing system (200.2) in accordance with one or more embodiments of the disclosure. In contrast to FIG. 2.1, FIG. 2.2 shows an embodiment where the well completion recommender (204.2) includes a cluster model (226) (e.g., instead of the classification model (214) of FIG. 2.1). The computing system (200.2) may be a computing system such as described below with reference to FIGS. 5.1 and 5.2. For example, the computing system (200.2) may be the E&P computing system described in reference to FIG. 1. In one or more embodiments, the computing system (200.2) includes a repository (202.2) and a well completion recommender (204.2). The repository (202.2) includes well data (210.2) for a well and reference well data (222) for reference wells. The well data (210.2) includes features (212.2) of the well. The reference wells may be any wells for which reference well data (222) is available. The reference well data (222) includes features (212.3) and tool recommendations (224) for the reference wells. The tool recommendations (224) may be tools that have been previously recommended for the reference wells (e.g., in order to complete the reference wells).

The well completion recommender (204.2) includes functionality to recommend, given the features (212.2) of the well, a tool (220) that may be used during completion of the well. The well completion recommender (204.2) includes a cluster model (226). The cluster model (226) includes functionality to group reference wells into well clusters (228) using the features (212.3) of the reference wells. The cluster model (226) may be a hierarchical clustering model that groups the reference wells at different granularities. The well completion recommender (204.2) may recommend the tool (220) to be used during completion of the well based on tool recommendations (224) for the reference wells in a well cluster that is most similar to a specific well, as described in Block 356 below.

While FIG. 2.1 and FIG. 2.2 show configurations of components, other configurations may be used without departing from the scope of the disclosure. For example, various components may be combined to create a single component. As another example, the functionality performed by a single component may be performed by two or more components.

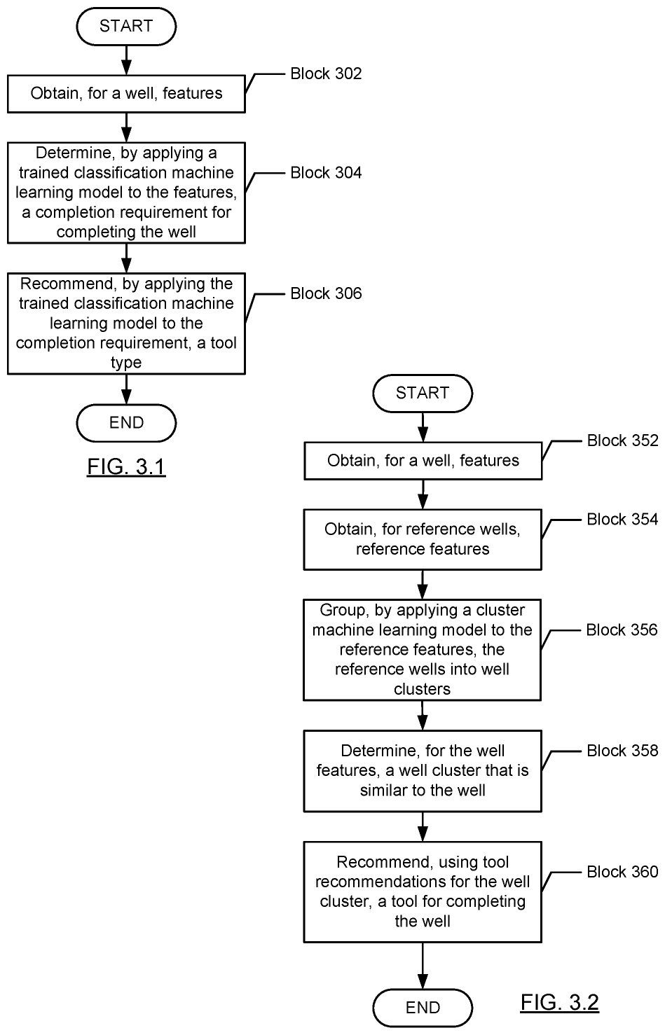

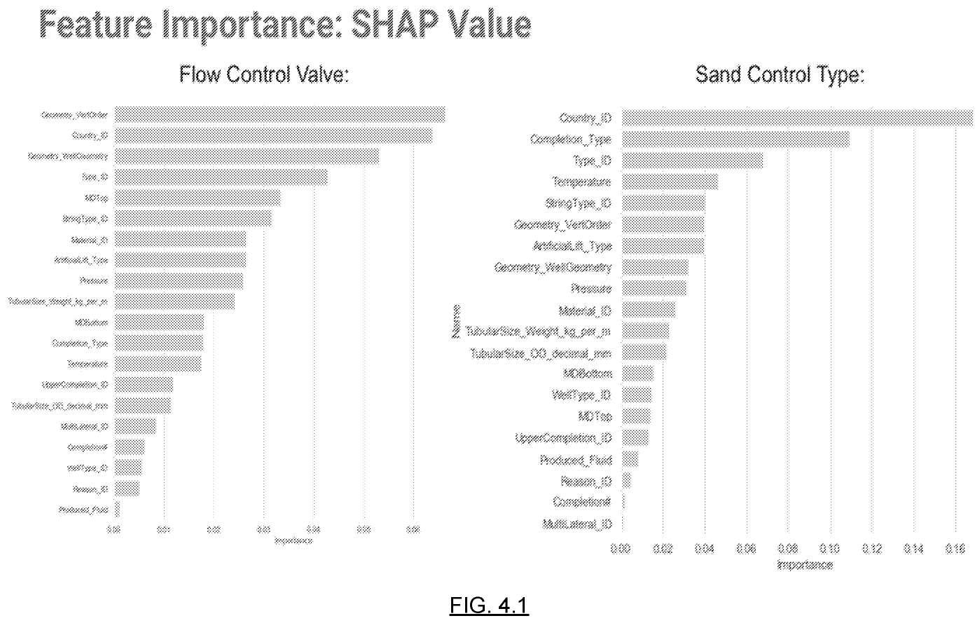

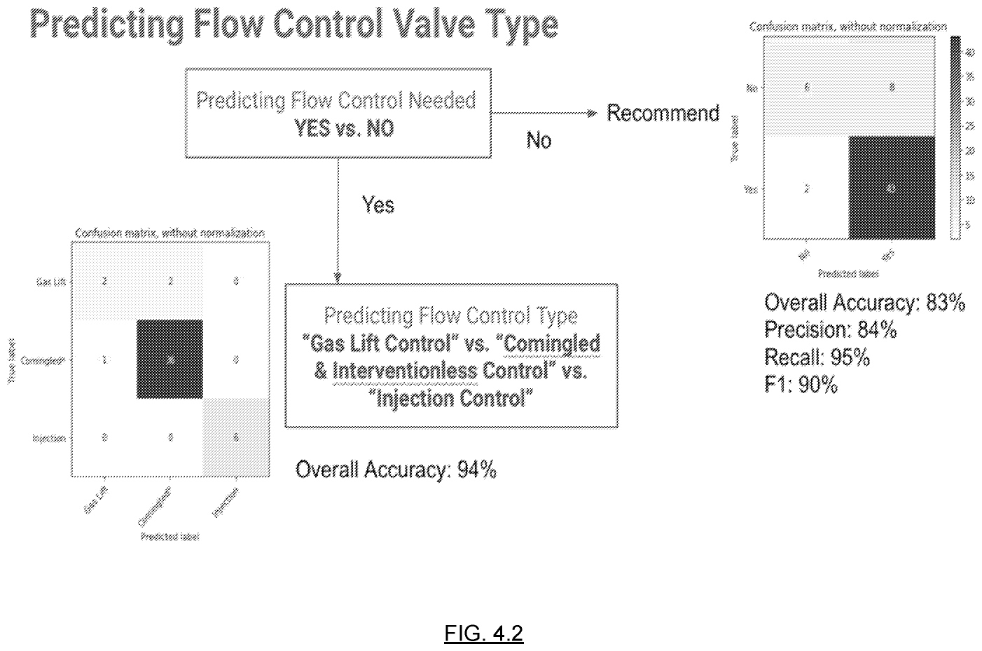

FIG. 3.1 shows a flowchart in accordance with one or more embodiments of the disclosure. The flowchart depicts a process for completing a well. One or more of the steps in FIG. 3.1 may be performed by the components (e.g., the well completion recommender (204.1) of the computing system (200.1)) discussed above in reference to FIG. 2.1. In one or more embodiments, one or more of the steps shown in FIG. 3.1 may be omitted, repeated, and/or performed in parallel, or in a different order than the order shown in FIG. 3.1. Accordingly, the scope of the disclosure should not be considered limited to the specific arrangement of steps shown in FIG. 3.1.

Initially, in Block 302, features are obtained for a well. The features may be obtained from well data for the well stored in a repository. For example, the features may be categorical and/or numerical features of subsurface formations. A subset of features may be selected based on relevance to the tasks of classifying a completion requirement and/or a tool type to fulfill the completion requirement.

In Block 304, a completion requirement for completing the well is determined by applying a trained classification machine learning model to the features. Training data may be pre-processed prior to training the classification machine learning model. The pre-processing step may include data cleaning, feature engineering, and/or oversampling, as described below.

Feature Engineering: Missing feature values may be derived from known information about the data distribution of the feature. For categorical features, missing values may be replaced by the most common value for that feature (e.g., the mode value of the feature). In addition, one hot encoding may be applied to categorical features to facilitate consumption by the machine learning model. For numerical features, missing values may be replaced with the value corresponding to the 50th percentile of that feature (e.g., the median value of the feature). To account for possible typographical and/or input errors, outlier values may be removed from numerical features. For example, removing outliers removed less than 1% of the training data in a sample training dataset.

Cross validation and Oversampling (e.g., using the synthetic minority over-sampling technique (SMOTE)): A 10-fold cross-validation procedure may be applied to calculate the accuracy of the prediction using training and validation datasets. For example, a validation may apply a slightly modified SMOTE oversampling technique to the training dataset to help reduce data imbalance for one or more tasks (e.g., the tasks of predicting a completion requirement and predicting a tool type that satisfies the completion requirement).

With the pre-processed training data, the performance of tool prediction may be tested using different classification models, including Stochastic Gradient Descent (SGD), Naive Bayes, K-nearest neighbor, Random Forest, Support Vector Machine (SVM), and XGBoost. Empirical results suggest that Random Forest yields the highest accuracy for the validation and test set, resulting in the least overfitting of the training data. For example, the accuracy, precision, recall, and F1 scores were above 80% for Sand Control and Fluid Control tool type predictions for a sample training dataset, as shown in FIG. 4.2, which shows performance results for predicting the flow control tool type.

Additional optimization functions may be added to the classification machine learning model so that tool recommendation may be customized to match different well completion objectives (e.g., a budget for well completion, a requirement to use specific tools, the demand and/or supply of tools at different locations, risk levels for different probabilities of recommending tools, etc.). To increase the effectiveness of the recommendations, user feedback in response to the recommendations may be incorporated to reduce biases from historical data used in training data, and to reduce the recommendation of unnecessary tools or technologies. In addition, the availability of well completion designs may further improve the performance of the machine learning model.

In Block 306, a tool type is recommended by applying the trained machine learning model to the completion requirement (see description of Block 304 above). The well completion recommender may further recommend a specific tool corresponding to the tool type using one or more additional models and/or tool selection criteria (e.g., using the process of FIG. 3.2 below).

FIG. 4.3 shows an example of a pipeline of steps performed by the well completion recommender.

FIG. 3.2 shows a flowchart in accordance with one or more embodiments of the disclosure. The flowchart depicts a process for completing a well. One or more of the steps in FIG. 3.2 may be performed by the components (e.g., the well completion recommender (204.2) of the computing system (200.2)) discussed above in reference to FIG. 2.2. In one or more embodiments, one or more of the steps shown in FIG. 3.2 may be omitted, repeated, and/or performed in parallel, or in a different order than the order shown in FIG. 3.2. Accordingly, the scope of the disclosure should not be considered limited to the specific arrangement of steps shown in FIG. 3.2.

Initially, in Block 352, features are obtained for a well (see description of Block 302 above).

In Block 354, reference features are obtained for reference wells (see description of Block 302 above). The reference wells may be any wells for which features and tool recommendations are available.

In Block 356, the reference wells are grouped into well clusters by applying a cluster machine learning model to the reference features. The reference wells within a well cluster may be similar to one another with respect to a distance calculated from one or more features (e.g., feature vectors) of the reference wells. For example, the reference wells within a well cluster may be within a threshold distance of a center point (e.g., a centroid) of the well cluster. In one or more embodiments, the reference wells within a well cluster may be similar to one another based on whether categorical features of the reference wells match and/or whether numerical features of the reference wells are within a threshold range of one another. The number of reference wells in the well cluster may depend on whether the cluster model is a hierarchical model. For example, a hierarchical model may group the reference wells into larger or smaller well clusters depending on the granularity of the features used to perform the clustering.

In Block 358, a well cluster that is similar to the well is determined by applying a cluster model to the reference features. The well cluster may be the closest well cluster to the specific well whose features were obtained in Block 352 above. For example, the closest well cluster may be based on distances calculated between the features of the specific well and the centroids of the well clusters.

In Block 360, a tool for completing the well is recommended using tool recommendations for the well cluster. For example, the well completion recommender may recommend one or more tools that have been recommended with the greatest frequency for the reference wells in the well cluster. A user may then analyze the one or more tools.

Embodiments of the disclosure may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5.1, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities that implement the features and elements of the disclosure.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (500) in FIG. 5.1 may be connected to or be a part of a network. For example, as shown in FIG. 5.2, the network (520) may include multiple nodes (e.g., node X (522), node Y (524)). A node may correspond to a computing system, such as the computing system shown in FIG. 5.1, or a group of nodes combined may correspond to the computing system shown in FIG. 5.1. By way of an example, embodiments of the disclosure may be implemented on a node of a distributed system that is connected to other nodes. By way of another example, embodiments of the disclosure may be implemented on a distributed computing system having multiple nodes, where a portion of the disclosure may be located on a different node within the distributed computing system. Further, one or more elements of the aforementioned computing system (500) may be located at a remote location and connected to the other elements over a network.

Although not shown in FIG. 5.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5.1. Further, the client device (526) may include and/or perform all or a portion of one or more embodiments of the disclosure.

The computing system or group of computing systems described in FIGS. 5.1 and 5.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system in FIG. 5.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where a token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 5.1, while performing one or more embodiments of the disclosure, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B >0). In one or more embodiments, B may be considered a threshold, and A is deemed to satisfy the threshold if A=B or if A>B, as determined using the ALU. In one or more embodiments of the disclosure, A and B may be vectors, and comparing A with B involves comparing the first element of vector A with the first element of vector B, the second element of vector A with the second element of vector B, etc. In one or more embodiments, if A and B are strings, the binary values of the strings may be compared.

The computing system in FIG. 5.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions present a few examples of functions performed by the computing system of FIG. 5.1 and the nodes and/or client device in FIG. 5.2. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited by the attached claims.

1. A method for completing a first well, comprising:
obtaining, for the first well, a first plurality of features;
determining, by applying a trained classification machine learning model to the first plurality of features, a completion requirement for completing the first well; and
recommending, by applying the trained classification machine learning model to the completion requirement, a tool type.

2. The method of claim 1, wherein the trained classification machine learning model is based on a deep learning model or a neural network.

3. The method of claim 1, whereinw in the trained classification machine learning model is based on convolutional neural networks (CNNs)), random forests, stochastic gradient descent (SGD), a lasso classifier, gradient boosting, bagging, adaptive boosting (AdaBoost), ridges, elastic nets, or Nu Support Vector Regression (NuSVR), or a combination thereof.

4. The method of claim 1, further comprising:
pre-processing training data, training a classification machine learning model to obtain the trained classification machine learning model.

5. The method of claim 4, wherein the pre-processing includes data cleaning, feature engineering, oversampling, or a combination thereof.

6. The method of claim 1, further comprising:
testing the recommendation using a classification model.

7. The method of claim 6, wherein the classification model is selected from a group consisting of: Stochastic Gradient Descent (SGD), Naive Bayes, K-nearest neighbor, Random Forest, Support Vector Machine (SVM), and gradient boosting.

8. The method of claim 1, further comprising:
adding one or more optimization functions to the trained classification machine learning model to match different well completion objectives.

9. The method of claim 1, further comprising:
obtaining, for a second well, a second plurality of features;
obtaining, for a plurality of reference wells, a plurality of reference features;
grouping, by applying a cluster machine learning model to the plurality of reference features, the plurality of reference wells into a plurality of well clusters;
determining, for the second plurality of well features, a well cluster of the plurality of well clusters that is similar to the second well; and
recommending, using tool recommendations for the well cluster, a tool for completing the second well.

10. The method of claim 9, wherein the reference wells within a well cluster are similar to one another with respect to a distance calculated from one or more features of the reference wells.

11. The method of claim 9, wherein the reference wells within a well cluster are similar to one another based on whether categorical features of the reference wells match and/or whether numerical features of the reference wells are within a threshold range of one another.

12. A system comprising:
a processor;
memory accessible by the processor; and
processor-executable instructions stored in the memory that are executable to instruct the system to:
obtaining, for the first well, a first plurality of features;
determining, by applying a trained classification machine learning model to the first plurality of features, a completion requirement for completing the first well; and
recommending, by applying the trained classification machine learning model to the completion requirement, a tool type.

13. The method of claim 12, wherein the trained classification machine learning model is based on a deep learning model or a neural network.

14. The method of claim 12, further comprising:
pre-processing training data, training a classification machine learning model to obtain the trained classification machine learning model.

15. The method of claim 12, further comprising:
testing the recommendation using a classification model.

16. The method of claim 12, further comprising:
adding one or more optimization functions to the trained classification machine learning model to match different well completion objectives.

17. The method of claim 12, further comprising:
obtaining, for a second well, a second plurality of features;
obtaining, for a plurality of reference wells, a plurality of reference features;
grouping, by applying a cluster machine learning model to the plurality of reference features, the plurality of reference wells into a plurality of well clusters;
determining, for the second plurality of well features, a well cluster of the plurality of well clusters that is similar to the second well; and
recommending, using tool recommendations for the well cluster, a tool for completing the second well.

18. The method of claim 17, wherein the reference wells within a well cluster are similar to one another with respect to a distance calculated from one or more features of the reference wells.

19. The method of claim 17, wherein the reference wells within a well cluster are similar to one another based on whether categorical features of the reference wells match and/or whether numerical features of the reference wells are within a threshold range of one another.

20. One or more computer-readable storage media comprising computer-executable instructions executable to instruct a computer to:
obtain, for the first well, a first plurality of features;
determine, by applying a trained classification machine learning model to the first plurality of features, a completion requirement for completing the first well; and
recommend, by applying the trained classification machine learning model to the completion requirement, a tool type.
